(19) United States
(12) Patent Application Publication
(10) Pub. No.: US 2014/0190224 A1
(43) Pub. Date: Jul. 10, 2014

(54) CONVERSION OF ORGANIC WASTE FROM PLANT AND ANIMAL SOURCES INTO A MICRONIZED FERTILIZER OR ANIMAL FEED

(71) Applicant: Larry V. Connell, Yakima, WA (US)

(72) Inventor: Larry V. Connell, Yakima, WA (US)

(21) Appl. No.: 14/098,521

(22) Filed: Dec. 5, 2013

Related U.S. Application Data
(63) Continuation-in-part of application No. 12/799,428, filed on Apr. 23, 2010, now abandoned.
Application No. 12/799,428 is a continuation-in-part of application No. 11/588,829, filed on Oct. 27, 2006, now abandoned.
(60) Provisional application No. 60/794,065, filed on Apr. 20, 2006.
(60) Provisional application No. 60/731,106, filed on Oct. 27, 2005.

(51) Int. Cl. A23K 1/10; A23K 1/14; C05B 17/00; A23K 1/00

(52) U.S. Cl. CPC A23K 1/106; A23K 1/007; A23K 1/146; C05B 17/00
USPC 71/16; 426/54; 426/635; 426/473

(57) ABSTRACT

A process for the conversion of organic materials raw waste and other marine plants and animals into a stable powder form, without high heat or cooking A raw waste is ground and then optionally hydrolyzed or enzymatically reduced to form a hydrolysate and transferred to a blender for nutrient mixing, to form a raw product that is dried in a high velocity air dryer and micronizer, which can simultaneously dry and grind the raw product within a ball mill's work chamber with a high velocity exhaust stream from an inline pulse engine. The finely ground raw fish or animal waste may be pressed or blended with other nutrients to satisfy feed and fertilizer requirements. The final product may be further milled, granulated, pelletized or classified to meet market suspension standards for drip, pivot, and other applications for feeding plants and animals.

This Non-Provisional Application is a Continuation-in-Part of currently pending Non-Provisional application Ser. No. 12/799,428 filed Apr. 23, 2010, which claimed priority to Non-Provisional application Ser. No. 11/588,829 filed Oct. 27, 2006, now abandoned, which claimed priority to Provisional Patent Application Ser. No. 60/731,106, filed Oct. 27, 2005, and to Provisional Patent Application, Ser. No. 60/794,065, filed Apr. 20, 2006. Each patent application identified above is incorporated here by reference in its entirety to provide continuity of disclosure.

### FIELD OF INVENTION

The present invention relates to the conversion of organic waste materials, including raw animal and plant wastes, into a stable small micron particle sized powder and granular forms.

### BACKGROUND

Sixteen elements are known to be essential for ideal genetic expression in plants, and for maximizing plant growth. These elements are generally considered to be: carbon, hydrogen, oxygen, nitrogen, phosphorus, potassium, calcium, magnesium, sulfur, boron, chlorine, copper, iron, manganese, molybdenum, and zinc. The Earth is essentially a closed system, in which these sixteen elements are recycled or moved from one location to another, for example; from the top soil to the ocean, or into the atmosphere. In nature, we observe a precise recycling of these critical elements. When we disrupt the natural cycle, we place our sources of food, fiber, and energy in jeopardy. And so, it is vital for humanity to work in harmony with nature's recycling processes.

Humanity has in some ways short-circuited nature with large scale agricultural practices. Soil, which provides the nutrients required to grow the healthy crops on which we depend, is quickly depleted. In attempts to industrialize and scale-up farming practices, which include the planting of a rapid succession of nutrient sapping crops that cannot replenish the soil, nature's replenishing processes are bypassed. To supplement or supplant nature, farmers must turn to industrial sources to provide fertilizers to keep the soil infused with the sixteen required nutrients and vital organic materials. There is a need to economically produce these essential nutrients in a form readily available for use in a feed or fertilizer, resulting in a more commercially viable animal and plant food.

### BRIEF DESCRIPTION OF DRAWINGS

FIG. 1A is a schematic of a preferred process of the present invention;

FIG. 1B is a schematic of a preferred alternative process of the present invention;

FIG. 2 is a schematic of a preferred alternative in a process of the present invention;

FIG. 3 is a schematic of a preferred alternative in a process of the present invention;

FIG. 4 is a schematic of a preferred alternative in a process of the present invention;

FIG. 5 is a schematic of a preferred alternative in a process of the present invention;

FIG. 6 is a side view of a preferred alternative in a process of the present invention; and

FIG. 7 is a section view 7-7 from FIG. 6, of a preferred alternative in a process of the present invention.

### DETAILED DESCRIPTION OF PREFERRED EMBODIMENTS

The proper ratios and manipulation of essential nutrients required for ideal plant growth can be facilitated by combining industrial mineral sources with plant and animal materials, to form the ideal ratios and formulations. Previous works of the present inventor, namely found in U.S. Pat. Nos. 6,461,399 and 5,466,273, detail processes for converting manures and farm waste into fertilizer products. A desired result of these conversions is a more commercially viable animal and plant food. The process of the present invention converts raw fish, animal and plant waste materials, into a product preferably having a stable powdered form, without the use of high heat in the digesting or cooking process including composting. Additional organic materials may be added to stabilize or otherwise augment the above product.

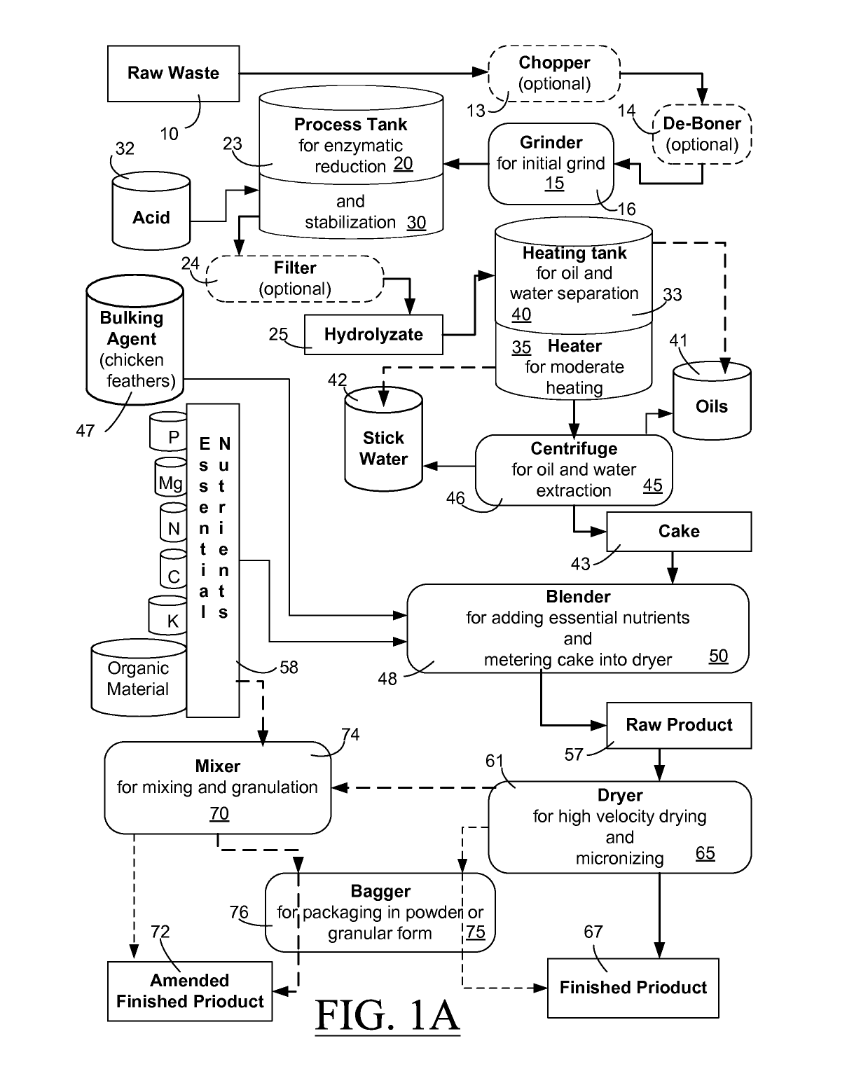

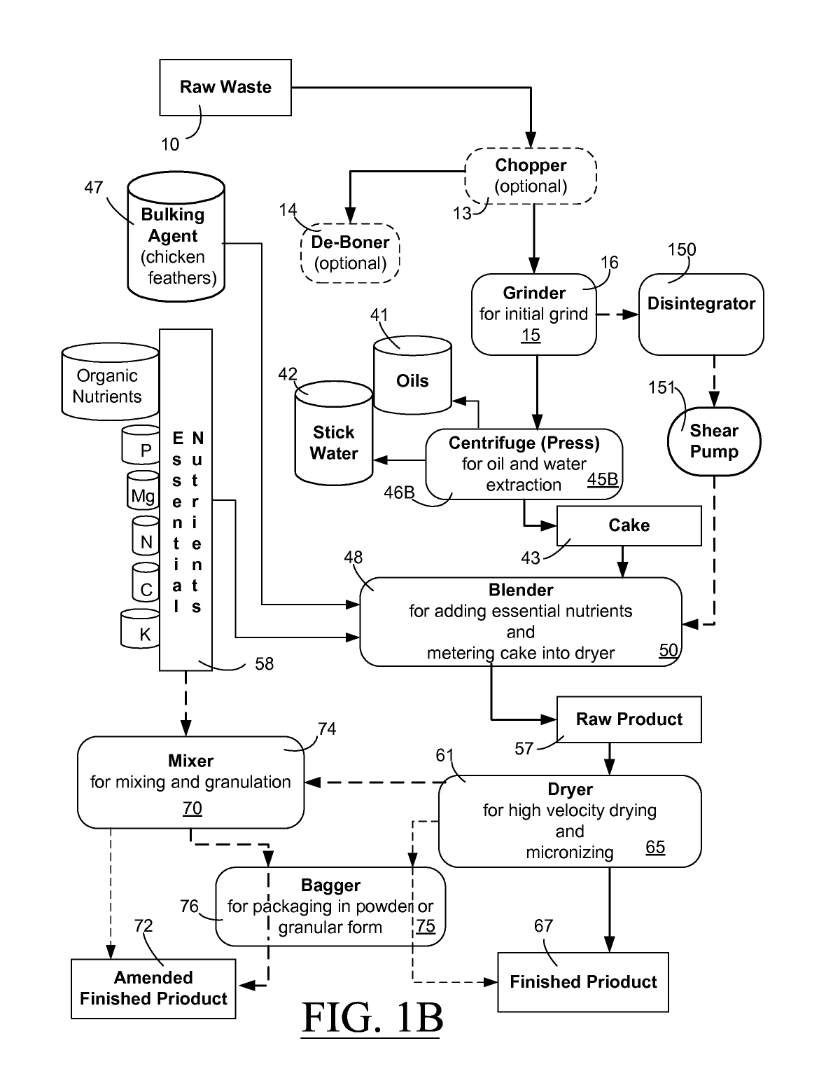

Preferred embodiments of the process of the present invention are schematically shown and detailed in FIGS. 1A through 7. As shown in FIG. 1A, a raw waste 10 is initially ground 15 in a grinder 16, and then hydrolyzed or “enzymatically reduced” 20, within a process tank 23. This hydrolyzation is achieved by enzyme additives self-contained, enzyme reactions within the raw waste, to form a hydrolysate 25.

To manufacture animal feeds, one would use a variation on the above procedure, and include the initial separation of bone from the tissues in the initial grind 15 of the raw fish and animal waste 10. As shown in FIG. 1A, with dashed elements to denote optional procedures or process equipment, this variation is accomplished through gentle stirring and separation of tissue and skeleton of the waste, preferably followed by screening with a conventional screen, filter, or most preferably by use of a de-boner 14, to maximize the protein and minimize the calcium and phosphorous being separated, which in-turn decreases the ash content. A chopper 13 may also be employed, preferably upstream of the de-boner, to aid in separating the bones prior to grinding.

Within the process tank 23, the enzymatic reduction also referred to as hydrolyzation 20 is followed by a stabilization 30, through the addition of an acid 32, the acid employed in this biological stabilization may be any appropriate acid employed in feed and fertilizer formulation, most preferably a sulfuric acid, a phosphoric acid, a humic acid, an organic sulfonic acid or a citric acid. The acid is employed to lower the pH of the fish hydrolysate. Most preferably, the pH is not lowered below a pH value of 3.5.

The hydrolysate 25 is then transferred to a heating tank 33, where it undergoes a moderate heating 35. This moderate heating step is preferably a gentle heating of the hydrolysate to approximately 120 to 150 degrees Fahrenheit (to 65.5 degrees Celsius) to achieve an oil and water separation 40, without boiling the solution. The term “approximately” is used herein to refer to a range of values or relative orientations, understood by a person skilled in the pertinent field or skill, as being substantially equivalent to the herein stated values in achieving the desired results, a range typical to the accuracy and precision of conventional tooling, instrumentation or techniques, or a functionally equivalent range of features that produces equivalent results to those described herein. The oil and water separation within the heating tank may include a decanting of any oils 41 collecting at the top of the heating tank and any waters 42 separating from the hydrolysate, typically as a distinct layer below the oils. This separation is best achieved by minimizing stirring or agitation of the hydrolysate within the heating tank. The moderate heating is followed by injecting the heated substrate into a centrifuge 46.

Specifically, in this three-phase separation within the centrifuge 46, the oils 41 and waters 42 are both separated from a product cake 43, which is simply referred to herein as a “cake.” The centrifuge is preferably a conventional, three-phase, horizontal decanting centrifuge, as is well known to persons skilled in industrial separation technologies. The waters 42 are generally referred to herein as “stick water,” which is conventionally a tea colored, often brackish and nutrient rich liquid, ideal for use as a sprayed soil amendment. The centrifuge provides for the extraction of the oils and waters 45, with the extracted oils separate from the stick water, and furthermore retains the cake for additional processing.

In an alternative to, or in addition to the preferred use of the centrifuge 46, the oil concentration within the hydrolysate 25 can be diluted by addition of other waste streams to absorb the excess oils. For example, a bulking agent 47 may be blended into the hydrolysate. A most preferred bulking agent is chicken feathers, preferably pulverized or otherwise comminuted into a pulp or finely shredded consistency. Chicken feather are an ideal bulking agent in that they have a high pH and readily absorb oils, while adding solids to the hydrolysate mixture. In addition dry animal manures can act as bulking agents to absorb the excess oils and water from the hydrolysate. Other slaughter wastes from poultry, spent hens, hogs and cattle mortalities and slaughter waste could also be utilized, to provide increased nutrient levels, pH control and slow nitrogen release qualities. With the high pH of the chicken feathers, base additives are minimized or not required, as would be needed to neutralize the cake from the prior addition of the acid 32.

The cake 43 is the residual substrate of the fish hydrolysate 25, after the oils 41 l and stick water 42 are extracted. From the centrifuge 46, the cake is transferred to a blender 48. A primary purpose of the blender is for a nutrient mixing 50 into the cake to form a raw product 55. Specifically, the nutrient mixing includes the blending of an essential nutrient 58 into the cake. The essential nutrient can include any material that serves in some way to add to or supplement the cake with the nutrients generally recognized as essential, or other attributes needed for ideal plant and animal growth, such as pH adjustment, buffering, or balancing.

The raw product 57, which is essentially the cake 43 as amended with the essential nutrients 58 and now substantially dewatered and oil free, is ready to be dried and micronized 60, The dryer 61 is preferably a high velocity air dryer and micronizer, with sonic vibration capability, or an electric dryer used alone or in combination with the sonic air dryer, commercially available from Marion of Marion Iowa. Most preferably, the blender is employed to meter the raw product into the dryer 55. The high velocity air dryer and micronizer are employed for particle size reduction, mixing and drying of the raw product, converting it into a product 67, preferably capable of further size reduction to meet drip and pivot irrigation suspension standards.

In an optional alternative of the present process, if the essential nutrient 58 additives are in a soluble powder form, they may be blended 70 into the finished product 67 following the drying and micronizing 65 of the raw product, to form an amended finished product 72. A mixer 74 is preferably employed to perform this blending. As preferred, the mixer may also granulate 75 the amended finished product. The finished product 67 or the amended finished product 72 is ready for distribution and use in feed or fertilizer activities. A bagging 75 of the products in either powder or granular form is preferably performed to better manage the bulk product.

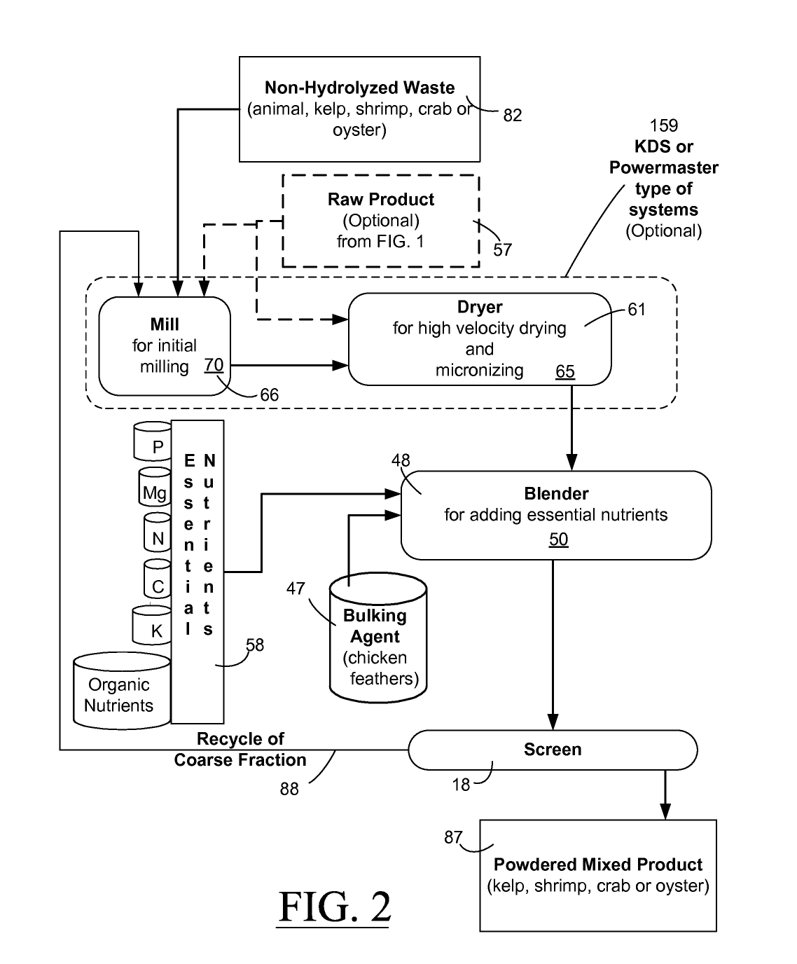

In an additional alternative embodiment of the present process, as detailed in FIG. 2, certain marine plants and animals such as crab, oyster, kelp and shrimp, which are a raw waste 10 all referred to herein as non-enzyme reduced or hydrolyzed waste 82, may be ground to a size that allows direct entry into the dryer 61, uniquely configured for high air velocity drying followed by micronizing 65, without any prior enzymatic hydrolysis and acid preparation. Additionally, spent hen chicken processing wastes are also ideally suited for use with the present invention. A mill 66, such as the model “1101GH” of the AUTIO brand of grinder, as manufactured by the Autio Company, of Astoria Oreg., USA, or alternatively, a comparable “Fitz” or Fitzpatrick brand of mill, discussed later herein, can be employed for an initial milling of the non-hydrolyzed waste. These powder forms of marine plant and animal waste can be blended with the fish hydrolysate formed by the process shown in FIG. 1A, and preferably in the form of the raw product 57. This blending provides the desired nutrient levels in a powdered mixed product 87, or the essential nutrients 58 may be added and blended 50 in the blender 48.

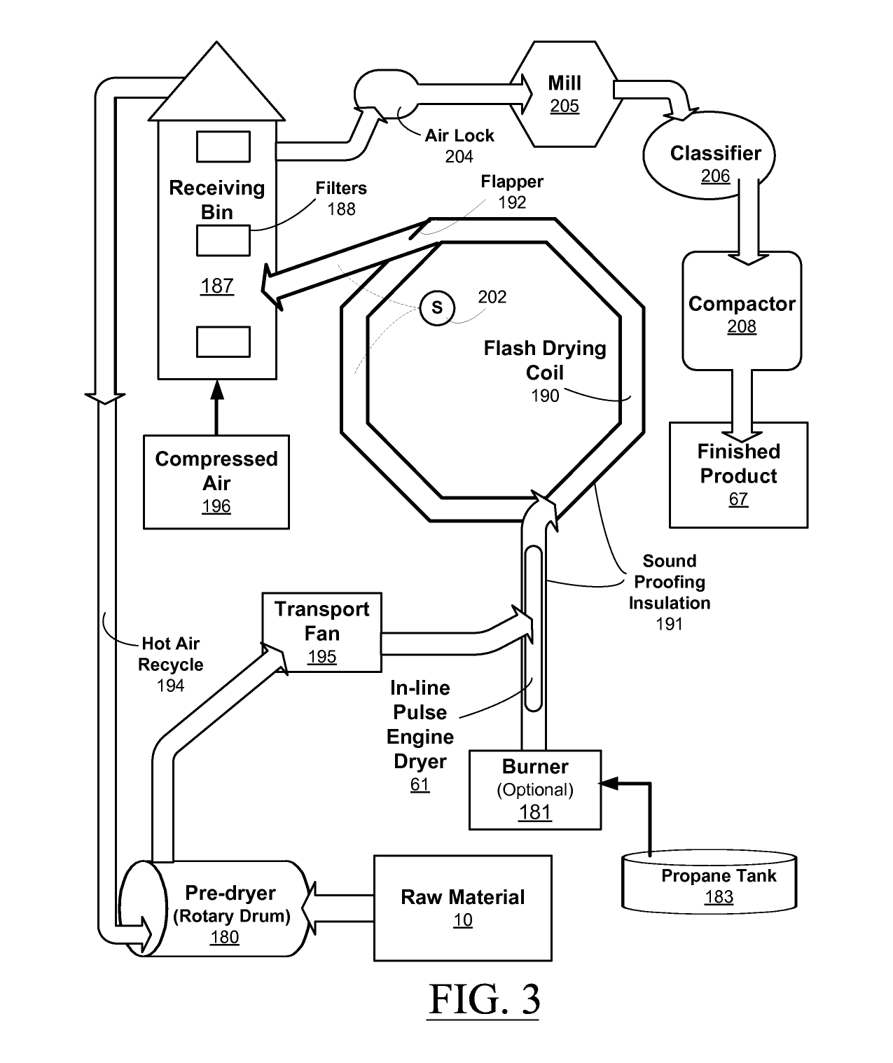

From the blender 48, the non-hydrolyzed waste 82 can be introduced into a screen 18, which may be a standard industrial ‘classifier,’ as shown in FIG. 3, to obtain a uniformly grained powdered mixed product 87. Again, the essential nutrients 58 introduced into the blender can include acids and various other nutrients, from the known roster of essential elements, to form complete nutrient quantities and ratios for distribution into the feed and fertilizer markets. As indicated in the coarse fraction recycle 88 from the screen, as shown in FIG. 2, some hard-shelled marine animals my need two passes through the mill 66, and the high air velocity micronizing 65 of the dryer 61, to obtain adequately preparation for the future micron milling for irrigation application.

As shown in FIG. 1B, in an alternative embodiment of the present invention, especially useful when processing certain raw wastes 10 that are reasonably well homogenized, either from prior chopping 13 and de-boneing 14, or as found with certain raw chicken processing waste, the raw wastes do not require treatment in the process tank 23 for enzymatic reduction 20 and stabilization 30, as previously discussed herein, and shown in FIG. 1A.

The alternative process of FIG. 2 eliminates the step of enzymatic reduction 20 and instead the raw fish 10 by grinding 15 and preferably an oil 41 and “stick”water 42 pressing in a press 45B, rather than the alterative centrifuge 45, to extract the oil and water 46B. This alternative process preferably employs the bulking agent 47, as discussed above, to adjust pH, increase nutrient value, and reduce water and oil concentration. Again, a preferred bulking agent is found to be chicken feathers, chicken litter and other carbon manure sources. The raw product material 10 is then dried using the drier 61, which is a high velocity gas engine with or without a commercial burner 181 prior to introduction into a product mill 205, as shown in FIG. 3.

Where economics dictate, an electric dryer may be used for the dryer 61, as manufactured by Marion Mixers of Marion, Iowa. A preferred product mill 205, used to further reduce particle size, is manufactured by Fitzpatrick Company, of Elmhurst, Ill. The blender 48 can then be used, to add essential nutrients 58, such as additional organic material. The finished product 67 is a fine mesh, dry powder useful as a fertilizer or feed.

A alternative preferred process of the present invention, essentially as shown in FIG. 2, may additionally include a micronizing CORENCO brand disintegator 150, discussed above, as the mill 66 for the initial milling 70. The disintegrator acts as the mill and feeder of the non-hydrolyzed waste 82 into the dryer 61. As shown in FIG. 1B, the disintegrator may used with a shear pump 151, such as “Boston Shearpump” brand of pumps, as manufactured by Admix, of Manchester, N.H.

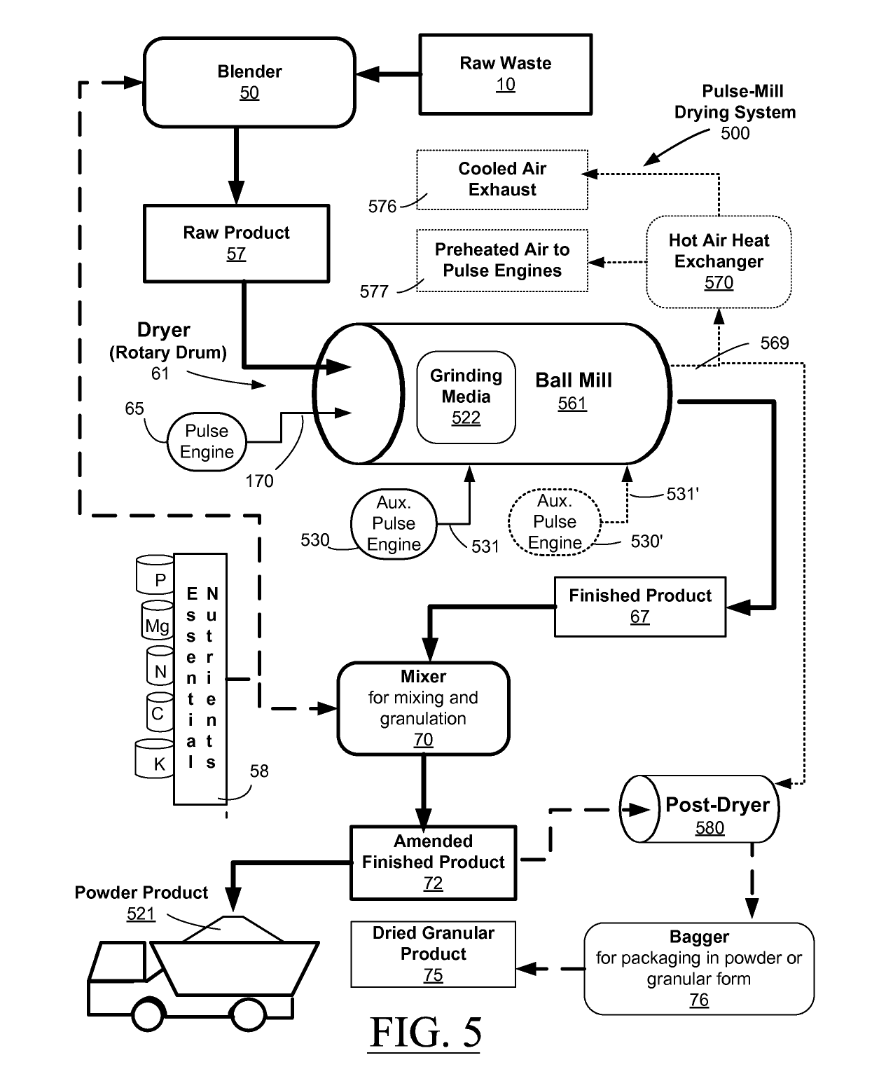

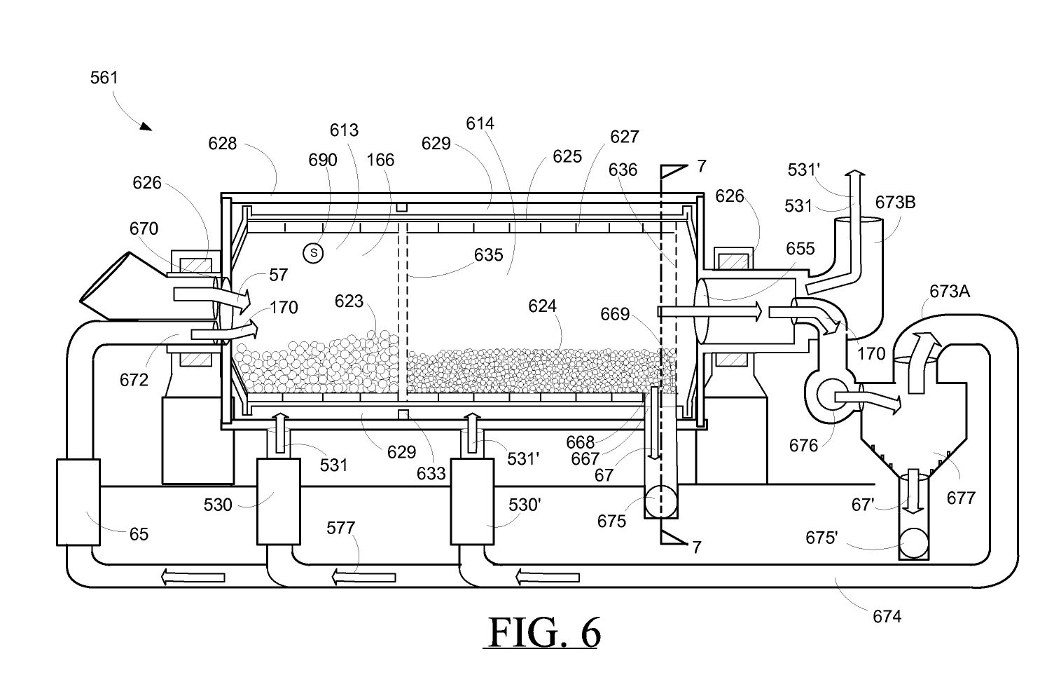

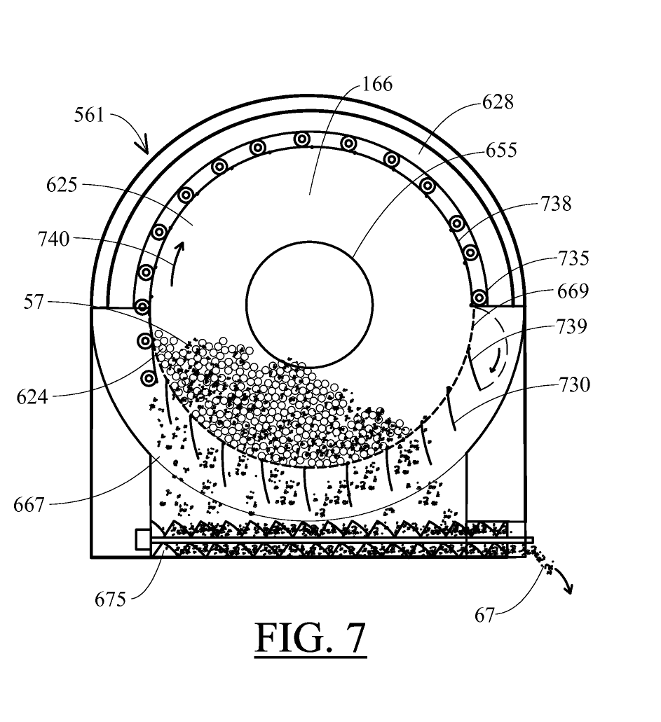

For an additional, improved embodiment of the present invention provides a superiorly efficient Pulse-Mill Drying System 500, as shown schematically in FIG. 5. For the Pulse-Mill Drying System, the above described Pulse Mill Dryer 61 as can be combined with a specifically designed and configured Ball Mill 561, as shown in FIGS. 5 through 7, which can be fitted with a Pulse Engine 65, as shown in FIGS. 6 and 7.

The Pulse Engine 65 may be referred to as a pulse-jet engine, or an in-line pulse engine, and is functionally equivalent to the High Velocity Gas Producing Combustion Engine to achieve the drying and micronizing, within the In-line Pulse Engine Dryer 61, as shown in FIGS. 1A, 1B, 2, 3 and 4, and discussed in preceding sections of this detailed description. A pulse jet engine, or pulsejet, is a type of air and fuel mixture combustion jet engine in which the combustion occurs in pulses, typically generating harmonic waves of pulsed exhaust. Pulse-jet engines can be made with few or no moving parts, and are capable of running statically, in place, for continuous periods of time.

The Ball Mill 561 is a rotary drum drier, supplemented with a Grinding Media 522. As shown in FIGS. 6 and 7, the Ball Mill is preferably portioned into two stages, a Coarse Stage 613 and a Fine Stage 614. The Raw Product 57 is received into the Coarse Stage at a Drum Feed 6

The unique combination of the Ball Mill 561 and Pulse Engine 65 in the Pulse-Mill Drying System 500 can be employed to convert the organic waste Raw Product 57 into a user friendly plant nutrient source as the Finished Product 67. Specifically, the combined pulse jet and ball-mill process of the Pulse-Mill Drying System performs four useful changes in the raw organic matter source, to transform it into a high grade organic and or organic based fertilizer as the Finished Product.

Four changes performed to the Raw Product 57 organic waste stream by the Pulse-Mill Drying System 500 are as follows:

1. Drying;

2. Particle reduction size;

3. Mixing to a homogenous balanced nutrient blend; and

4. Processing and screening to various mesh sizes, as needed.

As shown in FIG. 5, a Blender 50, which may be referred to herein as a ‘meter box’, and is commercially available from Marion of Marion Iowa, is employed to premix, blend and meter the Raw Product 57 waste material into the Dryer 61, which is the Pulse Engine 65 augmented Ball Mill 561 or ‘Pulse Grinder Organic Processor.’ Mixtures of the different Essential Nutrients 58 that are optionally introduced in the up-front Blender will be homogeneously mixed in powder form in a pass through the Ball Mill. Thus, the action of the Pulse-Mill Drying system 500 also serves to homogenize the Finished Product 67.

The preferred Dryer 61 is further detailed in FIGS. 6 and 7. Raw Waste 10 materials of different moisture and ‘stickiness’ can be introduced substantially indiscriminately into the Blender 50, due to the Dryer's ability to universally receive any typically organic feedstock. Such feedstocks can include municipal, industrial and agricultural biosolids, such as cow, chicken and hog manure, and ground animal mortalities.

These wide varieties of the Raw Waste 10 feedstocks can be processed by the Dryer 61 of Pulse-Mill Drying System 500 without major equipment alterations. The Pulse-Mill Drying System will perform the four processes listed above, to transform any of the feedstocks into a viable and user friendly organic fertilizer for the Finished Product 67. This is accomplished by combining the rotary drum Ball Mill 561 serving as a Work Chamber 166, with the Pulse Engine 65 providing heat, thrust, and sonic vibration to the Raw Product 57 processed within, by action of the Exhaust Stream 170 from the Pulse Engine.

The terms ‘sonic velocity’ and ‘sonic vibration’ are well known terms in the field of engineering, especially when pertaining to high the technology of velocity air flows found in the design and specification of pulse engines. Sonic velocity can be generally defined as the sound velocity of an internal fluid. With that definition, it is observed that the exhaust velocity from the typical pulse engine is at or above the velocity regime of sound waves, or at a “sonic velocity.” For instance, the exhaust from a pulse-jet includes ‘sonic vibrations’ in its exhaust gas stream with the hot gas emanating as the exhaust gas stream at a typical frequency of 30,000 to 60,000 cycles per second and an energy level of 40 to 200 decibels. The maximum gas-flow pulse velocity from the Pulse Engine 65 is expected to be up to approximately 0.5 to 5 times a typical sound velocity in free air, the typical sound velocity in free air being approximately 300 to 500 m/s (meters per second), depending on moisture content, temperature and altitude, and with time averaged operational levels within the Work Chamber 166 approximately 200 to 300 m/s.

The Grinding Media 522 within Ball Mill 561 can be any material as selected by persons skilled in grinding media material for ball mill type of tumbling drum mills, and is preferably a forged steel, cast steel or a cast iron. Most preferably, the Grinding Media is a short length of steel reinforcement bar, or ‘re-bar’ material, with a bar diameter suitable for use in the Ball Mill. The lengths of re-bar can be cut into segments of approximately one diameter in length. The resulting Grinding media is approximately cylindrical in shape, with sharp, circular ends. In a short amount of use within the Ball Mill, it is expected that the cylindrical form of the re-bar segments will round-off to more resemble a sphere or ball. It is expected that the flakes or chips produced by the abrasion and grinding on the re-bar Grinding Media within the Ball Mill will supplement elemental iron to the Finished Product 67, and therefore benefit its resultant formulations.

The grinding action of the rolling and colliding Grinding Media 522 in the Work Chamber 166 of the Ball Mill 561 provides the desired particle size reduction to the Raw Product 57 and constantly rotating surface area to exposure to high heat and dry air. By analogy, this processing within the working chamber 166 of the Ball Mill is generally similar to the ordinary process of stir-frying a pan of food, such as a vegetable and chicken mixture, where a constant movement to impart a rotating surface area of exposure to air, will quickly cook and simultaneously dehydrate the food within the ‘wok’ or frying pan, without burning the food.

It is observed that the Raw Product 57 organic matter will begin to carbonize and create smoke at around 400 degrees F. Temperatures of approximately 700 degrees F. can be maintained on the Raw Product, if a constant motion of the Raw Product is maintained within the Ball Mill 561. This movement, along with the subsonic vibration of the Pulse Engine 65, creates a condition that will inhibit substances from sticking, plugging, building-up, and burning. Moisture is readily driven off and no carbonizing or burning occurs as long as the heat is applied to the Raw Product while it is maintained in constant motion. Chicken, turkey or any other typical poultry carcasses generally referred to as ‘mortalities’ can be introduced into the Ball Mill, preferably pre-ground within the Blender 50, and fed into the Ball Mill as the Raw Product, will undergo the same treatment, providing for the simultaneous drying and grinding of this protein waste into the powdered Final Product 67.

As shown in FIGS. 6 and 7, the Ball Mill 561 includes a Rotating Drum 625 that rotates on a pair of Drum Bearings 626. Preferably, the Rotating Drum is an end peripheral-discharge type of Ball Mill with a Replaceable Steel Liners 627, which may be rubber liners in the alternative.

The Rotating Drum is surrounded by an Outer Casing 628. The Outer Casing is stationary, enclosing the Rotating Drum 625 to form an Annular Jacket 629. As shown in FIG. 6, an Auxiliary

Pulse Engine 530 is positioned proximate to the Annular Air Jacket, and provides an Auxiliary Pulse Engine Exhaust 531 that is routed into the Annular Air Jacket to heat the Rotating Drum of the Ball Mill.

The Annular Air Jacket 629 is essentially an air space surrounding the Rotating Drum 625 of the Ball Mill 561. In addition to heating the Rotating Drum, the Auxiliary Pulse Engine Exhaust 531 provides vibration action to the Raw Product 57 and Grinding Media 522 being processed within the Work Chamber 166. Most preferably, especially when the Ball Mill includes a multiple of internal compartments or stages, such as a Coarse Stage 613 and a Fine Stage 614, as shown in FIG. 6. A Second Auxiliary Pulse Engine 530′ can be positioned proximate to the Annular Air Jacket, with the Auxiliary Pulse Engine 530 serving the Coarse Stage containing the Large Grinding Media 623, and the Second Auxiliary Pulse Engine proving a Second Auxiliary Pulse Engine Exhaust 531′ that pumps into the Annular Jacket proximate to the Fine Stage, which contains the Small Grinding Media 624, as shown in FIG. 6.

For the overall dimensions and preferred engineered design of the Dryer 61, including the internal configuration of the Ball Mill 561 and Work Chamber 166 can be determined initially by the nature of the Raw Product 57 to be fed into it. As preferred, and shown in FIG. 6, the Work Chamber can be divided with an Intermediate Diaphragm 635, as is practiced in conventional mining processes employing ball mills. The Intermediate Diaphragm is essentially a screen positioned transverse to the flow of Raw Material through the Ball Mill. The Intermediate Diaphragm is sized to prevent the Grinding Media 522 from migrating through the Work Chamber of the Ball Mill, while allowing the Raw Product and the Pulse Dryer Exhaust 170 to flow through the Ball Mill. As preferred and shown in FIG. 6, the Work Chamber can be divided with an Intermediate Diaphragm 635. The Intermediate Diaphragm is essentially a coarse screen or grid that divides the Work chamber into the Coarse Stage 613 and the Fine Stage 614.

Additionally, a Jacket Baffle 633 can be included within the Annular Air Jacket 629, as shown in FIG. 6, proximate to the Intermediate Diaphragm 635. The a Jacket Baffle serves to compartmentalize the flow of the Auxiliary Pulse Engine Exhaust 531, separating it from the Second Auxiliary Pulse Engine Exhaust 531′ within the Annular Air Jacket. With this separation, the Auxiliary Pulse Engine 530 serves the Coarse Stage 613 of the Work Chamber 166 and the Second Auxiliary Pulse Engine 530′ serves the Fine Stage 614 of the Work Chamber.

In addition to the Intermediate Diaphragm 635, a Terminal Diaphragm 636, which is also essentially in the form of a screen, can be positioned transverse to the flow of Raw Material through the Ball Mill 561. The Terminal Diaphragm is sized with a mesh to prevent the Grinding Media 522 from exiting from the Work Chamber 166 of the Ball Mill, while allowing the Pulse Dryer Exhaust 170 to flow through the Ball Mill.

Additionally, to help the Raw Product 57 migrate through the Ball Mill 561, lifters can be utilized within the Work Chamber 166. Most preferably, an angling of the lifters in the form of a spiral configuration around the perimeter of the Work Chamber within the Ball Mill would be employed, to move and mix the Grinding Media 522, along with the processed Raw Product. After the Raw Product migrates through the Work Chamber and Diaphragm 635, as preferred, and is converted to the Finished Product 67, the Finished Product exits the Work Chamber through a Mill Discharge 667, which is preferably a Peripheral Outlet 668 from the Ball Mill, as shown in FIG. 7. A Peripheral Screen 669 is employed to prevent the Grinding Media, and specifically the Small Grinding Media 624, from exiting the Fine Stage 614 of the Work Chamber.

Preferably, a Trap Door 730 that is hingably mounted against the Peripheral Screen 669 around the circumference of the Rotating Drum 625 of the Ball Mill 561. Most preferably, as shown in FIG. 7, a multiple of Trap Doors are employed around the circumference of the Rotating Drum of the Ball Mill, and each Trap Door opens in turn to allow the Finished Product 67 to exit the Work Chamber within the Rotating Drum through the Mill Discharge 667, and into the Peripheral Outlet 668 from the Ball Mill.

The opening and closing operation of each of the Trap Doors 730 is achieved by a set of Door Rollers 735 also positioned around the upper circumference of the Rotating Drum 625 of the Ball Mill 561, as shown in FIG. 7. The Door Rollers maintain the Trap Doors in a Closed Position 738, and when the line of circumferentially placed Door Rollers terminate, at approximately the half-way point from the top of the Ball Mill, as shown, the Trapp Door falls into an Open Position 739 allowing the Finished Product 67 to exit from the Fine Stage 614 of the Work Chamber 166. As the Rotating Drum continues turning, preferably in the Direction of Rotation 740 as shown in FIG. 7, the trap Door is brought into a Closed Position 738 by the line of Door Rollers that begin proximate to the upper circumference of the Rotating Drum. The line of circumferentially placed Door Roller around the upper half of the Ball Mill serve to maintain the Trap Doors in the Closed Position, and again, each Trapp Door falls into the Open Position as the Rotating Drum continues to advance, again allowing additional Finished Product to exit from the Fine Stage of the Work Chamber.

After the Finished Product 67 exits the Work Chamber through the Mill Discharge 667 of the Ball Mill 561, an Auger 675 is preferably employed to retrieve the Finished Product from beneath the Ball Mill, as shown in FIGS. 6 and 7. Any equivalent material transfer means could be utilized to move the Finished Product for further processing, including gravity and pneumatic transfer systems, and conveyors mechanisms.

The action of the Exhaust Stream 170 from the Pulse Engine 65 is most efficient within the Work Chamber 170 if the sonic explosion of the Exhaust Stream gases can directly contact the external, water-rich coating typically present on each component particle of the Raw Product 57 that is being processed. Preferably, the Pulse Engine is best positioned proximate to an In-Feed 670 of the Ball Mill's rotating drum, as shown in FIG. 6, where the Raw Product is being introduced. Some types of Raw Waste 10, such as biosolids that aggregate in large sticky clumps would not be affected by this Pulse Engine Exhaust Stream placement. Shredding, or extruding into smaller size particles of these clumps by the Blender 50 would be necessary to benefit from the Exhaust Stream's sonic vaporization. The angle the pulse gases enter the work chamber is important so the engine thrust does not just blow out the distal end of the dryer. A circular motion of the Exhaust Stream is most desired, requiring the Ball Mill Supply Duct 672 to be placed at an angle to the Work Chamber. Again, the vaned effect of the spiral lifters also serves direct the air flows in a circulating spiral through the Work Chamber.

As shown in FIG. 5, a preferred option employed for the Pulse-Mill Drying System 500 includes a Hot Air Heat Exchanger 570, for the reclamation of heat from the various pulse engine exhausts, namely the Exhaust Stream 170 from the Pulse Engine 65, the Auxiliary Pulse Engine Exhaust 531 from the Auxiliary Pulse Engine 530, and the Second Auxiliary Pulse Engine Exhaust 531′ from the Second Auxiliary Pulse Engine 530′. These exhaust streams are either vented to the atmosphere, or as preferred combined into a Mill Exhaust Stream 569, with the Exhaust Stream from the Pulse Engine routed to a Ball Mill Exhaust Duct 673A and the Auxiliary Pulse Engine Exhausts combined routed to an Air Jacket Exhaust Duct 673B. The Ball Mill Exhaust Duct and Air Jacket Exhaust Duct can them be combined to form the Mill Exhaust Stream and fed into fed into the Hot Air Heat Exchanger. Within the Hot Air Heat Exchanger, heat is transferred to a Preheated Air to Pulse Engines 577, and the Mill Exhaust Stream with its temperature substantially reduced, becomes a Cooled Air Exhaust 576 and exits from Hot Air Heat Exchanger and can be vented to the atmosphere. From the Hot Air Heat Exchanger, Preheated Air to Pulse Engines is preferably routed to a Pulse Jet Supply Duct 674, with any additional needed make-up air from the atmosphere. Alternatively, the Mill Exhaust Stream 569 can be routed to the Post Dryer 580, for use in further drying the Amended Finished Product 72.

As shown in FIG. 6, the Exhaust Stream 170 exiting the Ball Mill Air Outlet 655 may contain Fugitive Finished Product 67′ that is able to pass the Terminal Diaphragm 636. The Exhaust stream can be routed from the Ball Mill 561 to a Mill Cyclone 677, to remove much of this remaining material. A System Fan 676 is preferably used to supply the Mill Cyclone and additional to maintain a negative pressure within the Rotating Drum 625. Additionally, a second auger 675′ can be employed to transfer any Fugitive Finished Product that exits the Mill Cyclone, as shown in FIG. 6.

Sensors 690 in the Work Chamber 166 of the Pulse Mill Dryer 61 are used for process feedback to control flow of the Raw Product 57 into the and fuel to the Pulse Engine 65, and help determine processing variable, such as rate of rotation for the Rotating Drum 625 and optimal Pulse Engine 65 operation, along with the Auxiliary Pulse engines 530, and 530′ if employed. Other or additional sensors may be utilized, to monitor the temperature, humidity, oxygen or other gas levels, and particle size of the Finished Product 67 within or exiting the Work Chamber.

For mobile use, the Pulse Mill Dryer 61 could be mounted on a truck bed. In this alternative, the Raw Product 57 would be loaded directly into the Blender 50, which would act as a ‘surge box’, to maintain the feed of Raw Product into the Ball Mill 561 at a constant rate. The dried Finished Product 67 could be conveyed into a nurse truck for delivery to a central processing facility. At the central processing plant, the Finished Product could go to a second ball mill without the pulse engine for greater size reduction, if necessary to satisfy some potential markets. If the product meets moisture and particle size requirements obtained on the mobile unit, it can go directly to the Mixer 70 for the mixing, granulation or homogenization processes. The Amended Finished Product 72 being processed at the mobile unit facility could be rerun or further processed in the Post-dryer 580, if moisture content is considered as too high. However, for the Pulse-Mill Drying System 500 the target moisture of the Finished Product 67 may be as high as approximately 18 to 30 percent by weight of water. Depending on the desired end-use of the product, and whether it is to be granulated, micronized, pelletized or use in an irrigation system, the additional moisture may be acceptable or possibly advantageous.

### EXAMPLE 1

Raw waste 10 can include fresh, whole or waste fish and related fishing wastes, which are a byproduct of fishing operations and processing of wild and farm fish, and additionally from operations, such as the processing of crab, krill, shrimp, sea weed and kelp; all provide an excellent feed stock source for the manufacture of plant and animal food. As shown in FIG. 1, the entirety of the raw waste, including all fleshy and bony parts, is pre-processed by manually or mechanically chopping it into preferably one to two cm diameter chunks, in a chopper 13, and then de-boning the raw waste in a de-boner 14. The de-boner is most preferably a pressure de-boner, as is well known in fish de-boning technologies. The chopper and de-boner are optional, in that certain wastes do not require bone removal. The optional pre-processing chopping and de-boning may already have been accomplished in the processing that first utilized the fish material, such as canning or packing operations. After the optional chopping and de-boning operations, the raw waste is pre-ground 11 in the initial grind 15. Again, for precise particle size reduction, the initial grind is preferably achieved with a conventional 1101GH model of AUTIO brand of grinder which includes a high speed pulverizing head, alternatively, a FitzMill® comminutor, as manufactured by Fitzpatrick of Elmhurst, Ill., or alternatively a Silverson mixer-homogenizer, as manufactured by Silverson Machines LTD., of Chesham Bucks, U.K, could be utilized. Again, the initial grind promotes tissue disintegration of the raw waste, and facilitates the release of natural enzymes present within the waste. These natural enzymes break down fish proteins into their simpler amino acid forms, releasing the oils 41 and water 42.

The acid 32, added to the process tank 23, is most preferably a sulfuric, a phosphoric, a humic, a sulfonic, or an acetic acid, each selectively added separately or in combination, as needed to provide stabilization through pH reduction, down to approximately 3.5 pH. A combination of acids may be employed, which may be useful to provide essential nutrients 58 to the hydrolysate 25. The resulting fish hydrolysate is excellent for use the manufacture of certified organic fertilizers, as formed in the finished product 67.

Additionally, after treatment in the process tank 23, the filter 24 may be used to remove any bone material 22 still present in the hydrolysate 25. This option is preferred, especially if the raw waste 10 includes bony fish, and is most preferably use with the optional chopper 13 and de-boner 14, discussed above.

### EXAMPLE 2

In a proposed embodiment of the present invention, a typical hydrolysate 25, approximately 15% oil, 60% water, and 25% solids, could be formed from typical raw waste 10, depending on fish type and stage of fish development. After the enzymatic reduction 20 and stabilization 30 in the process tank 23, the hydrolysate could then be transferred to the heating tank 33, where it is heated to a moderate non-protein denaturing temperature of approximately 140 degrees F. (60 degrees C.) to facilitate the separation 40 of the oil 41 and water 42 from the hydrolysate solids. The oil, water and hydrolysate solids are extracted 45 with the three phase horizontal decanting centrifuge 46. The hydrolysate solids are then transferred to a specially designed blender 48, for addition of essential nutrients 58 and introduction into the high velocity air micronizer and dryer 61.

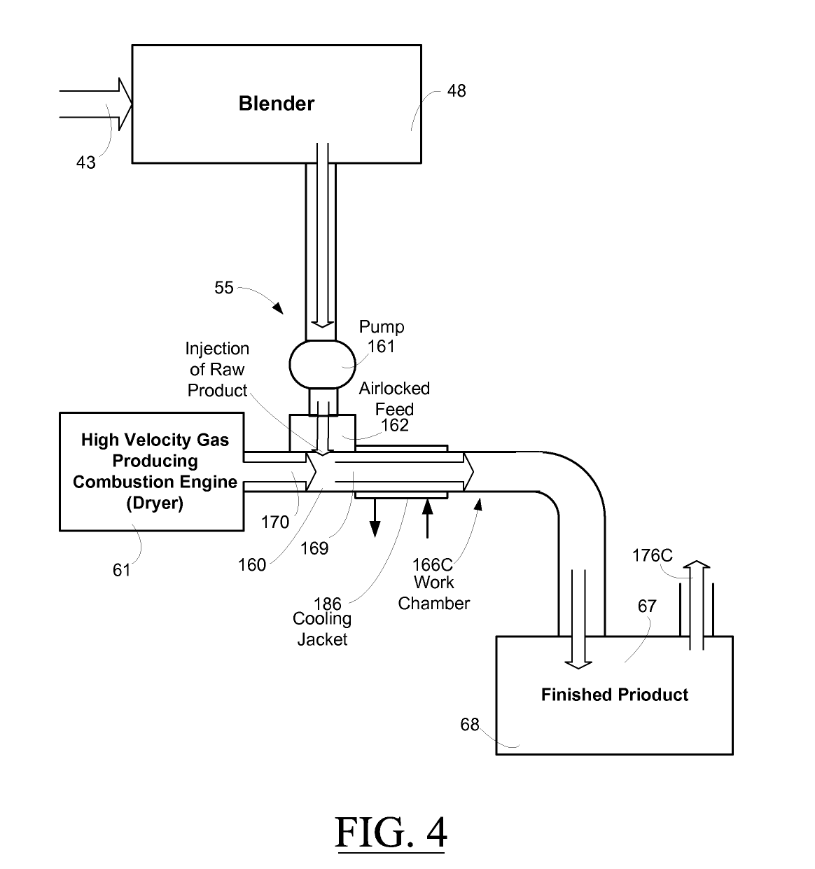

After the oil and water extraction 45 of the centrifuge 46, the cake 42 or fish hydrolysate solid, still would contain approximately 60 percent water, by weight. At this stage of the process, the cake exhibits a consistency similar to wet clay. If desired, the cake is then mixed or supplemented with essential nutrients 58, to form the raw product 57, and is then processed by the dryer 61 for high velocity air drying and initial micronizing 65. This process step preferably includes a metering of the raw product into the dryer 55 through a specially designed injector, prior to entry into the acceleration tube 160. A cooling jacket 186 can be utilized to cool the exhaust stream as it travels through the work chamber 166C, as shown in FIG. 4. The acceleration tube consists of a pipe with a diameter of approximately six to 12 inches (15-30 cm), and a length of approximately ten feet to thirty feet (three meters to nine meters), through which is flowing a high velocity air stream or the dryer exhaust stream 170. The acceleration tube is preferably made of stainless steel or a high density plastic, or alternatively a steel pipe that is most preferably glass lined to reduce friction. The hydrolysate solids of the cake are preferably accelerated in the dryer exhaust stream to an approximate velocity of over 450 miles per hour (725 kilometers per hour), or approximately 40,000 feet per minute (12,000 meters per minute), before entering a comminution chamber within the dryer. Alternatively, a multiple of chambers may be employed. The hydrolysate admixture is at this time subject to physical forces that affect the ability of the water, because of the different densities of water and organic matter of the hydrolysate, to remain physically and chemically bound to each other. The air speed, along with the acceleration tube diameter and configuration, and the pressure, along with the internal comminution chamber air stream obstacles, or lack of them, and proper venting of the water-organic matter separation chamber, all play a critical roll in the effectiveness of the micro-aerosol water and organic matter separation. The particle disintegration that also occurs during the high velocity impaction inside the comminution chamber allows the separation of free water, and bound water. Typical air velocities necessary to accomplish this drying and particles size reduction should be in the approximate range of 40,000 feet per minute (12,200 meters per minute). This is subsonic velocity is developed with system static pressure as high as approximately 15 psig (103 kPa).

### EXAMPLE 3

In a proposed embodiment of the present invention, a raw waste 10 containing 70 percent water by weight, could be chopped 13 and initially ground 15, then centrifuged and processed with a pre-dryer 180, as shown in FIG. 3, or bulked with dryer waste material 46 and metered 55 into the primary dryer 61. The pre-dryer is most preferably a rotary drum type of dryer, as is well known in the field of bulk material drying.

The metered introduction into the primary dryer 61 may be supplemented with a pressurized injection, as shown in FIG. 4, preferably employing an auger or similar forcing mechanism. The dryer is an in-line, pulse type of engine, either alone or utilized in combination with a conventional gas burner 181, served by a propane tank 183, or other fuel source. It is predicted that this source material would pass through the system with a final result of 12-15 percent water moisture, by weight. The approximately 27 cubic inch, or about 0.015 cubic foot pulse engine should run at approximately 750 firings per minute to produce approximately eleven cubic feet of hot, high speed air per minute, at around 300 psig of impact force. The in-line pulse engine is preferably wrapped in a sound proofing insulation 190, as is well known in the field.

The fertilizer source material 10 is fed into the acceleration tube and processed through the work chamber in the preferred form of a coil tube, as shown schematically in FIG. 3, having an overall length of approximately thirty feet or more, comprising of twelve to eighteen inch pipe, or larger. Preferably, the single spiral coil would be approximately twelve feet or more in diameter. The pipe is preferably insulated and the dried raw product 164 contents empty into a receiving bin 187 fitted with power bin filters 40, for separation of condensed water from within the holding bin environment.

A hot air recycle 194 can be utilized to return moist hot air from the receiving bin 187 to the pre-dryer 18, as shown in FIG. 3. Additionally, a compressed air 196 can be introduced into the receiving bin to remove caked finished product 67 from the filters 40 or cool the product. A flapper 192 is employed to regulate the recirculation of the drying material around the flash drying coil 190. The flapper is a standard type of hinged control valve, which is preferably controlled by from input received from a set of sensors 202, denoted as ‘S’ in FIG. 3. The sensors monitor the temperature, humidity and particle size in the flash drying coil at the exit and in the recirculation loop of the coil, as shown schematically.

The finished product 67 from flash drying coil 190 should measure approximately 15 percent water moisture by weight and is ready to be transferred to the receiving bin 187 and then to the micronizing product mill 205, preferably by way of an airlock 204. Additionally, beyond segregating and screening the finished product with the classifier 18, a compactor 206 can be used to granulate the finished product, as needed.

### EXAMPLE 4

In actual pilot runs of different potential raw wastes 10 for use with the processes of the present invention, a 1:1 mixture of waste and discarded wheat, as an organic material essential nutrient 58 referred to in Table 1, below as Fish/Wheat; a blended mix of fish bones referred to in Table 1, below as FishBones; a mix of discarded crab processing waste referred to in Table 1, below as Crab; a mix of fish bone meal processing waste referred to in Table 1, below as BoneMeal; and a mix of discarded fish and crab processing waste referred to in Table 1, below as Fish/Crab, were each individually processed employing the system essentially as schematically shown in FIG. 2. All of these products were under 100 standard mesh, with phosphate analyzed as P₂O₂, potassium as K₂O, and other than pH, all values are reported as weight percent to weight of total finished product 67. The following results were obtained:

TABLE 1

| | | | | | | Mois- |
|---|---|---|---|---|---|---|
| | Nitrogen | Phosphate | Potassium | Calcium | pH | ture |
| Fish/Wheat | 4.6 | 3.5 | 0.4 | — | 6.5 | 10 |
| FishBones | 6.03 | 3.7 | 0.6 | 3.9 | 7.8 | 5 |
| Crab | 5.9 | 4.2 | 0.6 | 3.2 | 7.6 | 12 |
| BoneMeal | 10.2 | 4.1 | 1.5 | — | 5.9 | 15 |
| Fish/Crab | 6.7 | 4.4 | 0.7 | — | 7.2 | 10 |

Having now described my invention, to those skilled in the art to which it pertains, it may become apparent that the need to make modifications without deviating from the intention of the design as defined by the appended claims.

What is claimed is:

1. A process for conversion of animal and plant waste materials into a feed and fertilizer powder comprising the steps of:
a) grinding a raw waste in a grinder;
b) enzymatically hydrolyzing the raw waste to form a hydrolysate;
c) stabilizing the hydrolysate through the addition of an acid to lower the pH of the hydrolysate;
d) heating the hydrolysate to achieve a separation of an oils and water from within the hydrolysate, and forming an oil and water layer in the hydrolysate;
e) decanting any of the oil and water layer collected on the hydrolysate;
f) separating the oils and the waters from the hydrolysate to form a product cake;
g) mixing a nutrient into the cake to form a raw product;
h) drying the raw product with an inline pulse engine;
i) routing a dryer exhaust stream from the inline pulse engine, the dryer exhaust stream containing a stream of the raw product through a working chamber with the stream of the raw product sonic accelerated to traveling at approximately a sonic velocity prior to entry into a receiving bin; and
j) drying and micronizing the raw product within the working chamber to form a product ready for further milling, classifying and compacting to meet suspension standards for drip and pivot irrigation or granular for conventional spreading or feeding.

2. A process for conversion of animal and plant waste materials into a feed and fertilizer powder comprising the steps of:
a) grinding a raw waste without enzymatic hydrolization to form a ground raw waste;
b) mixing the animal ground waste with a bulking agent
c) mixing a nutrient into the admixture to form a raw product;
d) drying the raw product in a work chamber with high velocity low pressure blower in conjunction with an inline pulse engine, the inline pulse engine supplying a dryer exhaust stream traveling at approximately a sonic velocity;
e) routing a dryer exhaust stream containing a stream of product particles through the dryer exhaust stream heated work chamber, prior to entry into a receiving bin mounted with a filter; and
f) micronizing and drying the raw product within the working chamber to form a final product, the final product ready for further micronizing, classifying and compacting.

3. A process for conversion of animal and plant waste materials into a feed and fertilizer powder comprising the steps of:
a) blending a raw waste to form a raw product;
b) simultaneously drying and grinding the raw product in a ball mill work chamber with a high velocity exhaust stream from an inline pulse engine, the ball mill including a grinding media for grinding the raw product, and the inline pulse engine supplying high velocity exhaust stream traveling at approximately a sonic velocity, with the sonic velocity greater than 200 meters per second; and
c) micronizing and drying the raw product within the working chamber to form a final product.

4. The process for conversion of animal and plant waste materials into a feed and fertilizer powder of claim 3, including the additional step of:
d) mixing a nutrient into the admixture to the raw product.

5. The process for conversion of animal and plant waste materials into a feed and fertilizer powder of claim 3, including the additional step of:
d) routing an auxiliary pulse engine exhaust from an auxiliary pulse engine to a jacket, the jacket surrounding a rotating drum of the ball mill.
